(19) United States
(12) Patent Application Publication
(10) Pub. No.: US 2010/0110584 A1
(43) Pub. Date: May 6, 2010

(54) Dual oxide recording sublayers in perpendicular recording media

(76) Inventors: Qing Dai, San Jose, CA (US); Hoa Van Do, Fremont, CA (US); Mary Frances Minardi, Santa Cruz, CA (US); Kentaro Takano, San Jose, CA (US); Kai Tang, San Jose, CA (US); Jinliu Wang, San Jose, CA (US)

Correspondence Address: HITACHI GLOBAL STORAGE TECHNOLOGIES, INC., 5600 COTTLE ROAD, NHGB/0142, IP DEPARTMENT, SAN JOSE, CA, 95193, US

(21) Appl. No.: 12/290,515

(22) Filed: Oct. 30, 2008

(51) Int. Cl. G11B 5/127; G11B 5/66

(52) U.S. Cl. 360/110; 428/831; G9B/5.241; G9B/5.04

(57) ABSTRACT

A method is described for improving recording performance of a perpendicular media. The method includes using a dual oxide layer as a sublayer of a magnetic recording layer of the perpendicular media. The dual oxide sublayer improves recording performance, increases resistance to corrosion and allows for a thinner exchange break layer. The dual oxide layer generally includes oxides of tantalum and one of silicon or boron.

### BACKGROUND OF THE INVENTION

1. Field of the Invention

This invention relates to perpendicular magnetic recording media, including continuous and patterned recording media, and more particularly to apparatus and methods for using oxides in sublayers of the recording layer.

2. Description of the Related Art

Hard-disk drives provide data storage for data processing systems in computers and servers, and are becoming increasingly pervasive in media players, digital recorders, and other personal devices. Advances in hard-disk drive technology have made it possible for a user to store an immense amount of digital information on an increasingly small disk, and to selectively retrieve and alter portions of such information almost instantaneously. Particularly, recent developments have simplified hard-disk drive manufacture while yielding increased track densities, thus promoting increased data storage capabilities at reduced costs.

In a hard-disk drive, rotating high precision media including an aluminum or glass disk that is coated on both sides with thin films designed to store information in the form of magnetic patterns. Electromagnetic read/write heads suspended or floating only fractions of micro inches above the disk are used to either record information onto the thin film media, or read information from it.

A read/write head may write information to the disk by creating an electromagnetic field to orient a cluster of magnetic grains, known as a bit, in one direction or the other. In longitudinal magnetic recording media applications, a magnetic recording layer has a magnetic c-axis (or easy axis) parallel to the disk plane. As the Hard-Drive industry is transitioning to perpendicular recording technology, adjustments are being made to adapt the disk media so that the magnetic easy axis (crystallographic c-axis) of the cobalt alloy recording layers grow perpendicular to the disk plane. Hexagonal Close Packed (HCP) cobalt alloys are typically used as a magnetic recording layer for perpendicular recording. Most media manufacturers now rely on a cobalt alloy with the incorporation of an oxide segregant to promote the formation of small and uniform grains.

To read information, magnetic patterns detected by the read/write head are converted into a series of pulses which are sent to the logic circuits to be converted to binary data and processed by the rest of the system. To write information, a write element located on the read/write head generates a magnetic write field that travels vertically through the magnetic recording layer and returns to the write element through a soft underlayer. In this manner, the write element magnetizes vertical regions, or bits, in the magnetic recording layer. Because of the easy axis orientation, each of these bits has a magnetization that points in a direction substantially perpendicular to the media surface. To increase the capacity of disk drives, manufacturers are continually striving to reduce the size of bits and the grains that comprise the bits.

The ability of individual magnetic grains to be magnetized in one direction or the other, however, poses problems where grains are extremely small. The superparamagnetic effect results when the product of a grain's volume (V) and its anisotropy energy (Kᵤ) fall below a certain value such that the magnetization of that grain may flip spontaneously due to thermal excitations. Where this occurs, data stored on the disk is corrupted. Thus, while it is desirable to make smaller grains to support higher density recording with less noise, grain miniaturization is inherently limited by the superparamagnetic effect. To maintain thermal stability of the magnetic grains, material with high Kᵤ may be used for the magnetic layer. However, material with a high Kᵤ requires a stronger magnetic field to reverse the magnetic moment. Thus, the ability of the write head to write on magnetic material may be reduced where the magnetic layer has a high Kᵤ value.

The perpendicular magnetic recording medium is generally formed with a substrate, a soft magnetic underlayer (SUL), an interlayer, an exchange break layer, a perpendicular magnetic recording layer, and a protective layer for protecting the surface of the perpendicular magnetic recording layer. The performance of the recording layer is important for efficient recording.

Accordingly, a need exists for a practical, attainable apparatus, system, and method for improving the perpendicular magnetic recording layer. Beneficially, such an apparatus, system and method would increase the recording performance of the system. Such apparatuses, systems and methods are disclosed and claimed herein. Further, the perpendicular magnetic recording layers should be able to resist corrosion.

### SUMMARY OF THE INVENTION

The present invention has been developed in response to the present state of the art, and in particular, in response to the problems and needs in the art that have not yet been fully solved by currently available apparatus, systems and methods. Accordingly, the present invention has been developed to provide apparatus, system and methods for improving the performance of the perpendicular magnetic recording layer.

Embodiment in accordance with the invention for a recording medium for perpendicular recording applications includes a soft magnetic underlayer deposited on a nonmagnetic substrate and a perpendicular magnetic recording layer deposited below an overcoat layer. Further, an exchange break layer is generally located between the soft magnetic underlayer and the perpendicular magnetic recording layer. The perpendicular recording layer includes a plurality of sublayers.

In certain embodiments, the magnetic recording layer consists of two sublayers: one oxide sublayer and one non-oxide sublayer. In other embodiments, a non-oxide sublayer or an exchange control sublayer is added to the two sublayers of the magnetic recording layer. In still another embodiment, both a non-oxide sublayer and an exchange control sublayer are added to the two sublayers of the magnetic recording layer.

In a specific embodiment, a bottom sublayer of the two oxide sublayers includes two segregants. These segregants are Ta and B. Ta can be added to this bottom sublayer in amounts between 1 at. % and 5 at. % and preferably between 2 at. % and 3 at. %. B can be added to this bottom sublayer in amounts between 4 at. % and 10 at. % and preferably between 5 at. % and 7 at. %. Together, the Ta and B concentration in this bottom sublayer can be between 5 at. % and 15 at. % and preferably between 7 at. % and 10 at. %. The use of Ta as a segregant in a magnetic recording sublayer is advantageous because it promotes Cr segregation at the magnetic grain boundaries. The further addition of B reduces grain size and enhances grain boundary segregation by forming of a CrB alloy at the grain boundaries.

In another specific embodiment, a bottom sublayer of the two oxide sublayers includes two segregants. These segregants are Ta₂O₅ and SiO₂. Ta₂O₅ can be added to this bottom sublayer in amounts between 0.5 molecular % and 3 molecular % and preferably between 1 molecular % and 1.5 molecular %. SiO₂ can be added to this bottom sublayer in amounts between 2 molecular % and 10 molecular % and preferably between 4 molecular % and 8 molecular %. Together, the Ta₂O₅ and SiO₂ concentration in this bottom sublayer can be between 2.5 molecular % and 13 molecular % and preferably between 4 molecular % and 10 molecular %. The use of dual Ta₂O₅ and SiO₂ enhances intergranular decoupling in the magnetic layer at relatively low total segregant content for better magnetic and corrosion properties.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic of a hard-disk drive;

FIG. 2 is a cross-section view of the layers of a perpendicular recording media in accordance with one embodiment of the present invention;

FIG. 3 is a view of one embodiment of a perpendicular recording media including a detailed view of the sublayers of the magnetic recording layer;

FIG. 4 is a view of a second embodiment of a perpendicular recording media including a detailed view of the sublayers of the magnetic recording layer;

FIG. 5 is a view of a third embodiment of a perpendicular recording media including a detailed view of the sublayers of the magnetic recording layer;

FIG. 6 is a graph of the relation between EBL thickness and jitter for three different experimental media;

FIG. 7 is a graph of overcoat thickness versus anodic current at 1V of an experimental media; and

FIGS. 8a and 8b are diagrams of two media structures.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are disclosed to provide a thorough understanding of embodiments of the present invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

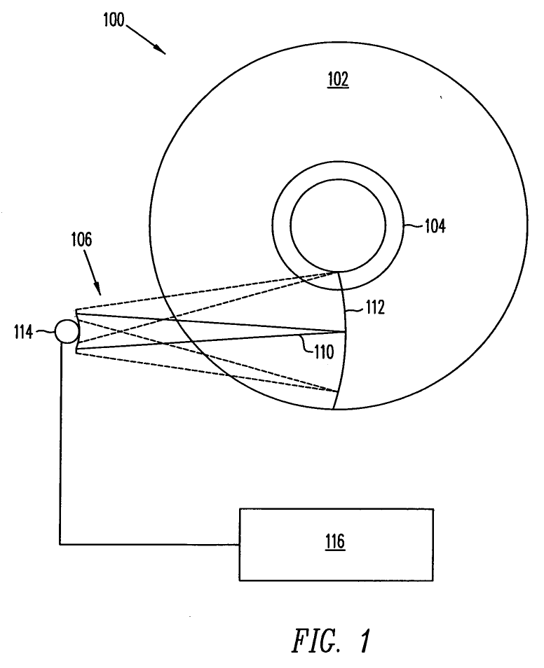

Referring now to FIG. 1, a diagram of a conventional hard-disk drive assembly 100 is shown. A hard-disk drive assembly 100 generally comprises a plurality of hard disks comprising a perpendicular magnetic recording media 102, rotated at high speeds by a spindle motor (not shown) during operation. The perpendicular magnetic recording media 102 will be more fully described herein. Concentric data tracks 104 formed on either or both disk surfaces receive and store magnetic information.

A read/write head 110 may be moved across the disk surface by an actuator assembly 106, allowing the head 110 to read or write magnetic data to a particular track 104. The actuator assembly 106 may pivot on a pivot 114. The actuator assembly 106 may form part of a closed loop feedback system, known as servo control, which dynamically positions the read/write head 110 to compensate for thermal expansion of the perpendicular magnetic recording media 102 as well as vibrations and other disturbances. Also involved in the servo control system is a complex computational algorithm executed by a microprocessor, digital signal processor, or analog signal processor 116 that receives data address information from an associated computer, converts it to a location on the perpendicular magnetic recording media 102, and moves the read/write head 110 accordingly.

Specifically, read/write heads 110 periodically reference servo patterns recorded on the disk to ensure accurate head 110 positioning. Servo patterns may be used to ensure a read/write head 110 follows a particular track accurately, and to control and monitor transition of the head 110 from one track 104 to another. Upon referencing a servo pattern, the read/write head 110 obtains head position information that enables the control circuitry 116 to subsequently re-align the head 110 to correct any detected error.

Servo patterns may be contained in engineered servo sectors 112 embedded within a plurality of data tracks 104 to allow frequent sampling of the servo patterns for optimum disk drive performance. In a typical perpendicular magnetic recording media 102, embedded servo sectors 112 extend substantially radially from the perpendicular magnetic recording media 102 center, like spokes from the center of a wheel. Unlike spokes however, servo sectors 112 form a subtly arc-shaped path calibrated to substantially match the range of motion of the read/write head 110.

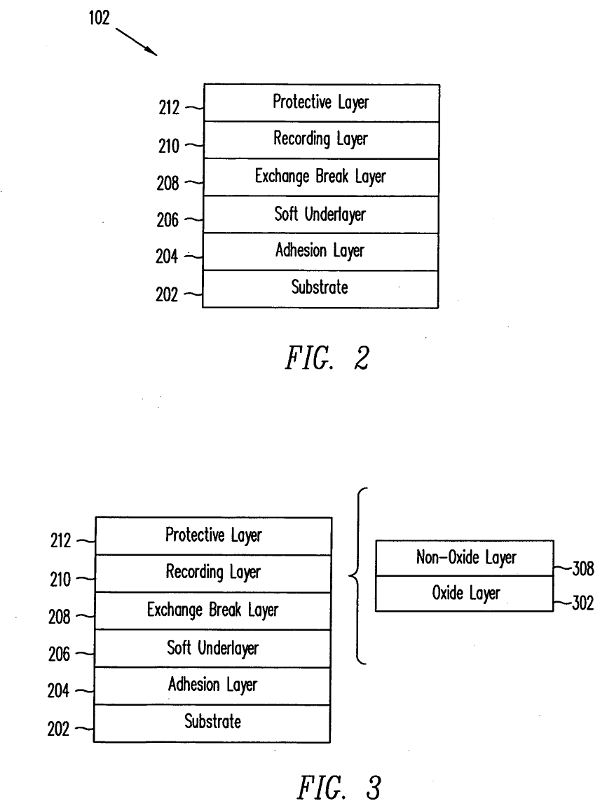

FIG. 2 is a cross-sectional view of a typical perpendicular magnetic recording media 102. The layers shown in FIG. 2 may be deposited on a substrate 202 or on an adhesion layer 204 previously deposited on the substrate 202. The layers may include a soft underlayer (SUL) 206 an exchange break layer 208 (EBL), a perpendicular magnetic recording layer 210 and an overcoat 212. The perpendicular magnetic recording media 102 may include other layers not shown in FIG. 2. Similarly, one skilled in the art will recognize that some of the layers illustrated in FIG. 2 may be omitted in certain embodiments.

The platter or substrate 202 may comprise an AlMg or glass platter which provides a rigid support structure upon which the recording media is deposited. In certain embodiments ion beam deposition or magnetron sputtering may be utilized to deposit the various layers comprising the perpendicular magnetic recording media 102.

In one embodiment, the first layer deposited on substrate 202 is an adhesion layer 204. The adhesion layer 204 may comprise an AlTi layer to aid in the adhesion of subsequent layers. In certain embodiments the adhesion layer 204 may be omitted and a soft underlayer 206 may be deposited directly on the substrate 202. The material comprising the soft underlayer 206 is a soft, magnetic alloy. In certain embodiments the material comprising the soft underlayer 206 may be CoFeTaZr.

The soft underlayer 206 may also be formed as an antiferromagnetic structure. A coupling layer may be disposed between two the soft underlayers to antiferromagnetically couple the two soft underlayers. The antiferromagnetic structure may be used to reduce magnetic signals originating from the soft underlayers where such signals are undesirable in the perpendicular magnetic recording media 102.

Above the soft underlayer 206 an exchange break layer 208 may be added. The exchange break layer helps to prevent the soft underlayer 206 from magnetically coupling to the magnetic recording layer 210.

The magnetic recording medium 102 also includes a magnetic recording layer above the exchange break layer 210, to store data. The magnetic recording layer 210 may include thin films with a plurality of magnetic grains, each grain having a magnetic easy axis substantially perpendicular to the media surface. This allows the grains to be vertically magnetized. The magnetic grains may comprise a magnetic material such as CoPt or CoPtCr or CoPtCrB. To maintain a highly segregated magnetic layer, one or more segregants may be added to the magnetic material.

Above the magnetic recording layer 210 is a protective layer 212. The protective layer is generally made of a carbon bilayer, the bottom layer being CHx and the top layer being CNx. The protective layer both mechanically protects the magnetic recording layer 210 as well as prevents corrosion of the magnetic recording layer 210.

The magnetic recording layer 210 can be configured in many different arrangements. FIGS. 3-5 describe three possible arrangement of the magnetic recording layer 210. FIG. 3 shows a media with magnetic recording layer 210 having two sublayers 302 and 308. The bottom sublayer 302 includes an oxide while the top sublayer 308 does not include an oxide. In addition, various layers can be introduced between sublayer 302 and sublayer 308 to improve the performance of the media. Sublayer 308 is generally a CoPtCr alloy.

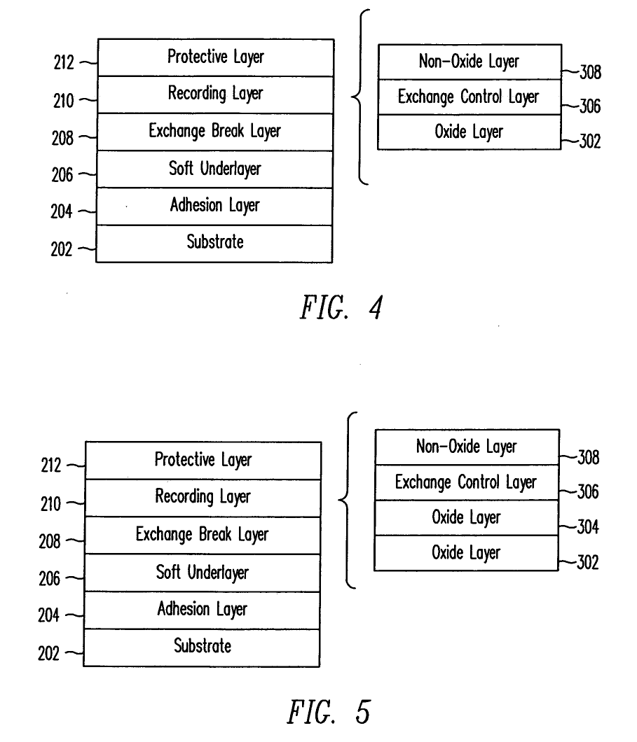

FIG. 4 describes a second possible arrangement for magnetic recording layer 210. In this arrangement, an exchange control layer (ECL) 306 is placed between the oxide sublayer 302 and the non-oxide sublayer 308 of the magnetic recording layer 210. The ECL 306 may be formed of Co alloys including Ru, Cr, Pt and/or B. The ECL 306 provides for a reduction of interfacial exchange coupling strength between the oxide sublayer 302 and the non-oxide sublayer 308.

FIG. 5 describes a third possible arrangement for the magnetic recording layer 210. In this arrangement, a second oxide sublayer 304 is located between ECL 306 and oxide sublayer 302. The advantage of the second oxide layer is to enhance corrosion resistance and to adjust magnetic and recording properties of the PMR media.

Oxide sublayer 302 may be made of an alloy of CoPtCrTa₂O₅B₂O₃ or CoPrCrTa₂O₅SiO₂. Both of these materials are advantageous as oxide sublayer 302.

In an embodiment of the media having an oxide sublayer 302 made of an alloy of CoPtCrTa₂O₅B₂O₃, specific amounts of Ta and B can be advantageous. Ta can be added to this bottom oxide sublayer 302 in amounts between 1 at. % and 5 at. % and preferably between 2 at. % and 3 at. %. B can be added to this bottom oxide sublayer 302 in amounts between 4 at. % and 10 at. % and preferably between 5 at. % and 7 at. %. Together, the Ta and B concentration in this bottom sublayer can be between 5 at. % and 15 at. % and preferably between 7 at. % and 10 at. %. Generally, the concentrations in the bottom oxide sublayer 302 of Pt will be around from 14-20 at. % and of Cr will be around 12-25 at. %. Generally, the remainder of the bottom oxide sublayer will be Co, however, other materials may be added to the alloy as well. Further, the bottom oxide sublayer 302 with Ta and B has a thickness between 6 and 16 nm.

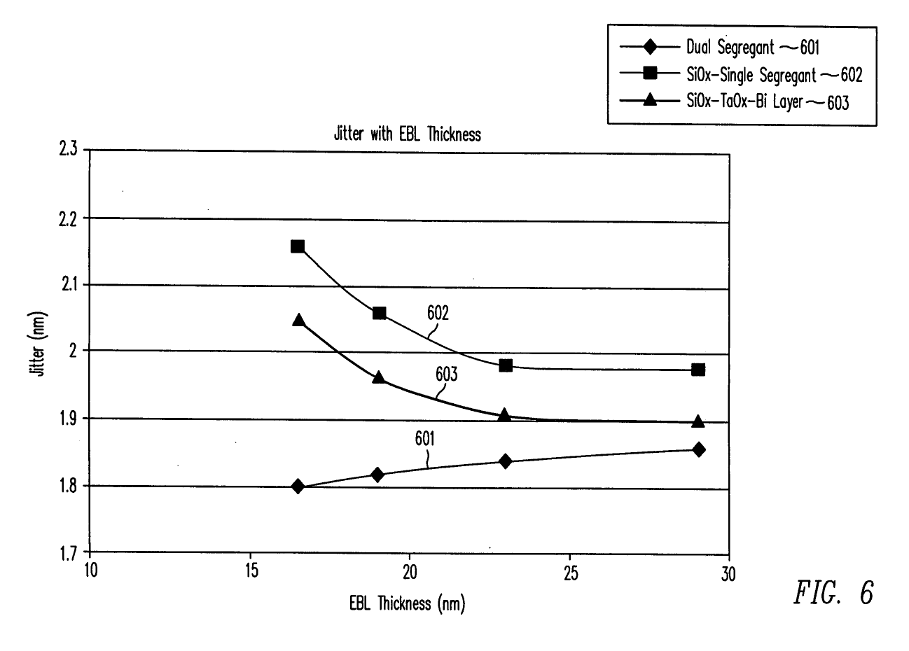

An advantage of using a CoPtCrTa₂O₅B₂O₃ alloy as a bottom oxide sublayer 302 is that it allows for a thinner EBL 208. FIG. 6 shows the relation between EBL thickness and jitter for the three different media configured as described in FIG. 3. The first media 601 has a bottom oxide sublayer 302 of Ta and B. The second media 602 includes a segregant with an alloy of CoPtCrSiO₂ as the bottom sublayer 302 and has no non-oxide layer 308. The third media 603 includes and alloy of CoPtCrSiO₂ as the bottom sublayer 302 and has no non-oxide layer 308. As can be seen from the graph, the first media 601 has superior jitter performance. Further, the jitter performance increases as the EBL 208 is thinned. Therefore, it is possible to use an EBL of 13 nm, or even smaller with this embodiment. Since the EBL is generally made from an expensive material, Ru, it is beneficial to be able to incorporate a thinner Ru EBL into magnetic media.

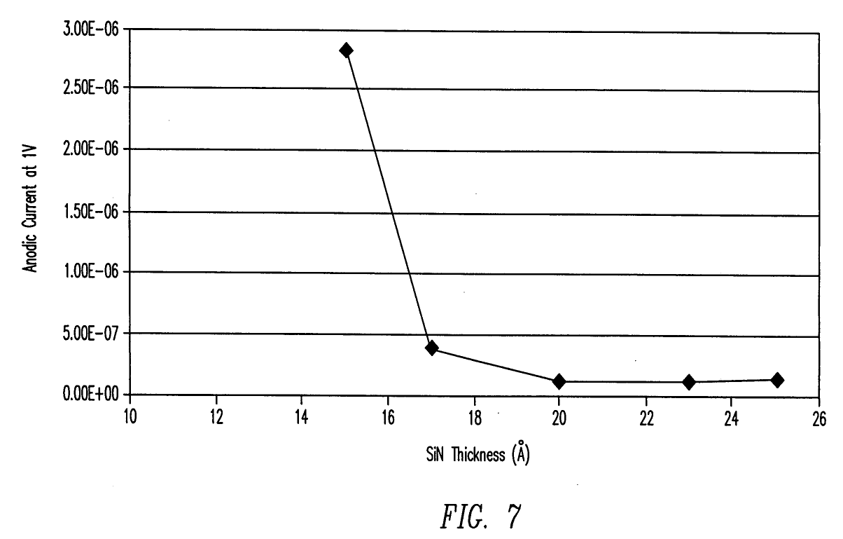

A second advantage of using a CoPtCrTa₂O₅B₂O₃ alloy as a bottom oxide sublayer 302 is that it allows for a thin protective layer 212. FIG. 7 is a graph of overcoat thickness versus anodic current at 1V. This test is used to determine the susceptibility of the media to corrosion. As can be seen from the graph, the media becomes far less susceptible to corrosion with an overcoat of only 17 angstroms, whereas a media with a bottom oxide sublayer 302 of CoPtCrTa₂O₅ will need a 25 A of overcoat in order to achieve the same degree of protection. Since thinner overcoats tend to provide better recording and readback performance, it is preferable that the overcoat be less than 25 angstroms or even 20 angstroms.

In an embodiment of the media having an oxide sublayer 302 made of an alloy of CoPtCrTaOSiO. Ta₂O₅ can be added to this-bottom oxide sublayer 302 in amounts between 0.5 molecular % and 3 molecular % and preferably between 1 molecular % and 1.5 molecular %. SiO₂ can be added to this bottom oxide sublayer 302 in amounts between 2 molecular % and 10 molecular % and preferably between 4 molecular % and 8 molecular %. Together, the Ta₂O₅ and SiO₂ concentration in this bottom oxide sublayer 302 can be between 2.5 molecular % and 13 molecular % and preferably between 4 molecular % and 10 molecular %. The thickness of oxide sublayer 302 is preferably between 6.75 nm and 7.5 nm and generally between 4 nm and 15 nm.

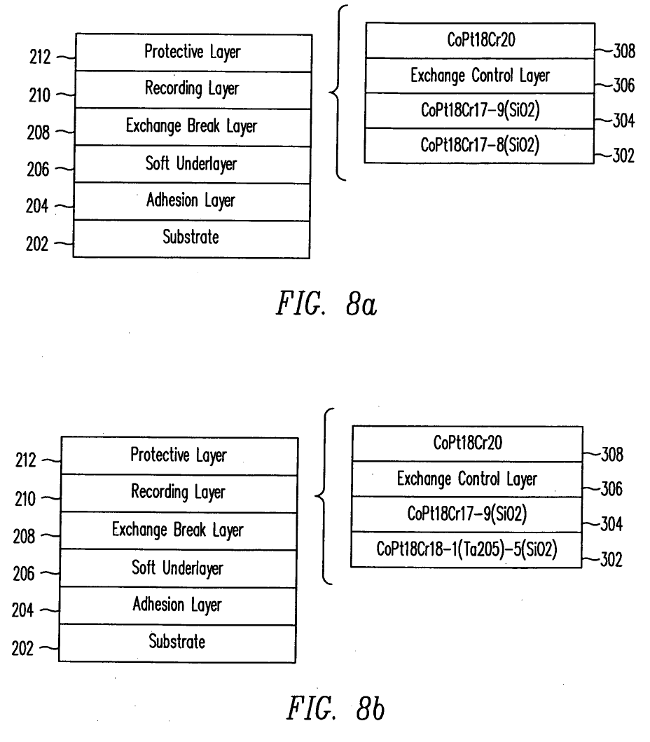

An advantage of using oxide sublayer 302 made of an alloy of CoPtCrTa₂O₅SiO₂ is that it improves 2TS0NR, 2TSNR, OW, T50 and jitter. Two media, media 1 and media 2, similar in construction to those of FIG. 5 were tested. The difference between the two media was Ta being added as a second oxide to the oxide sublayer 302 of the second media. FIG. 8a is a diagram of media 1 and FIG. 8b is a diagram of media 2. Table 1 below shows the results of testing the-two media showing the superiority of the dual oxide media.

TABLE 1

| | 2TS0NR | 2TSNR | OW | T50 | Jitter |
|---|---|---|---|---|---|
| Media 1 | 29.5 | 22.0 | 32.6 | 32.3 | 2.32 |
| Media 2 | 29.9 | 22.5 | 35.0 | 30.8 | 2.26 |

The media is manufactured in a sputtering device with several chambers. In each chamber, one or more of the layers is sputtered one on top of the other over a substrate. The chambers include at least one sputter target with the elements of the layer that is to be sputtered. In addition, the chambers include gases, such as oxygen, that can affect the composition of the sputtered layers. Lastly, the pressures in the chambers can be altered to affect the composition and properties of the various sputtered layers.

As an example, a substrate is sent into a first sputter chamber. In this first sputter chamber, an adhesion layer of AlTi is sputtered onto the substrate. The substrate is then passed to a second sputter chamber where a SUL layer of CoZrFeTa is sputtered onto the substrate. Next, the substrate is passed to a third sputter chamber where a EBL layer of Ru is sputtered onto the substrate. The substrate is then passed to successive sputter chambers to sputter the various sublayers of the magnetic recording layer and then the carbon overcoat layer. Lastly, lubricant is added to the substrate generally through a dipping process.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A perpendicular magnetic recording medium, comprising:
a soft magnetic underlayer deposited on a substrate;
an exchange break layer deposited on the soft magnetic underlayer;
a magnetic recording layer deposited on the exchange break layer; and
a protective layer deposited on the magnetic recording layer, wherein
the magnetic recording layer includes a first sublayer including Co, Pt, Cr and a second sublayer below the first sublayer including Co, Pt, Cr, and oxide of Ta and an oxide of B; and
the thickness of the exchange break layer is less than or equal to 13 nm.

2. The perpendicular magnetic recording medium of claim 1, wherein the thickness of the exchange break layer is less than of equal to 10 nm.

3. The perpendicular magnetic recording medium of claim 1, wherein
the concentration of Ta in the second sublayer is between 1 at. % and 5 at. %;
the concentration of B in the second sublayer is between 4 at. % and 10 at. %; and
the total concentration of Ta and B in the second sublayer is between 5 at. % and 15 at. %.

4. The perpendicular magnetic recording medium of claim 1, wherein
the concentration of Ta in the second sublayer is between 2 at. % and 3 at. %;
the concentration of B in the second sublayer is between 5 at. % and 7 at. %; and
the total concentration of Ta and B in the second sublayer is between 7 at. % and 10 at. %.

5. The perpendicular magnetic recording medium of claim 2, wherein
the concentration of Ta in the second sublayer is between 2 at. % and 3 at. %;
the concentration of B in the second sublayer is between 5 at. % and 7 at. %; and
the total concentration of Ta and B in the second sublayer is between 7 at. % and 10 at. %.

6. The perpendicular magnetic recording medium of claim 4, wherein,
the concentration of Pt in the second sublayer is between 14 at. % and 20 at. %; and
the concentration of Cr in the second sublayer is between 12 at. % and 25 at. %;
and the second sublayer has a thickness between 6 nm and 16 nm.

7. The perpendicular magnetic recording medium of claim 5, wherein,
the concentration of Pt in the second sublayer is between 14 at. % and 20 at. %; and
the concentration of Cr in the second sublayer is between 12 at. % and 25 at. %;
and the second sublayer has a thickness between 6 nm and 16 nm.

8. The perpendicular magnetic recording layer of claim 7, wherein the exchange break layer includes Ru.

9. The perpendicular media of claim 6, wherein the protective layer is between 17 angstroms and 25 angstroms.

10. The perpendicular media of claim 6, wherein the protective layer is between 17 angstroms and 20 angstroms.

11. A perpendicular magnetic recording medium, comprising:
a soft magnetic underlayer deposited on a substrate;
an exchange break layer deposited on the soft magnetic underlayer;
a magnetic recording layer deposited on the exchange break layer; and
a protective layer deposited on the magnetic recording layer, wherein
the magnetic recording layer includes a first sublayer including Co, Pt, Cr and a second sublayer below the first sublayer including Co, Pt, Cr, and an oxide of Ta and an oxide of Si; and
the concentration of Ta2O5 in the second sublayer is between 0.5 mol. % and 3 mol. %;
the concentration of SiO2 in the second sublayer is between 2 mol. % and 10 mol. %;
the total concentration of Ta2O5 and SiO2 in the second sublayer is between 2.5 mol. % and 13 mol. %;
the thickness of the second sublayer is between 4 nm and 15 nm; and
the thickness of the exchange break layer is less than or equal to 10 nm.

12. The perpendicular recording medium of claim 11, wherein,
the concentration of Ta2O5 in the second sublayer is between 1 mol. % and 1.5 mol. %;
the concentration of SiO2 in the second sublayer is between 4 mol. % and 8 mol. %;
the total concentration of Ta2O5 and SiO2 in the second sublayer is between 4 mol. % and 10 mol. %; and
the thickness of the second sublayer is between 4 nm and 15 nm.

13. A recording device for perpendicular recording applications, the recording device comprising:
a recording head for reading magnetic signals from, and writing magnetic signals to a recording medium; and
a recording medium configured for perpendicular recording, the recording medium comprising:
a soft magnetic underlayer deposited on a substrate;
an exchange break layer deposited on the soft magnetic underlayer;
a magnetic recording layer deposited on the exchange break layer; and
a protective layer deposited on the magnetic recording layer, wherein
the magnetic recording layer includes a first sublayer including Co, Pt, Cr and a second sublayer below the first sublayer including Co, Pt, Cr, and oxide of Ta and an oxide of B; and
the thickness of the exchange break layer is less than or equal to 13 nm.
